(19) United States
(12) Patent Application Publication
(10) Pub. No.: US 2022/0146109 A1
(43) Pub. Date: May 12, 2022

(54) HEATING COOKING APPARATUS

(71) Applicant: SHARP KABUSHIKI KAISHA, Sakai City (JP)

(72) Inventor: MUNESATO KUMAGAI, Sakai City (JP)

(21) Appl. No.: 17/412,968

(22) Filed: Aug. 26, 2021

(30) Foreign Application Priority Data
Nov. 11, 2020 (JP) 2020-187986

(51) Int. Cl. F24C 7/08; F24C 15/32

(52) U.S. Cl. CPC F24C 7/085; F24C 15/327

(57) ABSTRACT

A heating cooking apparatus includes a heating chamber, a housing, a communicating portion, and a sound detection unit. The heating chamber accommodates an object to be heated. The housing is configured to accommodate the heating chamber. The communicating portion is disposed between the heating chamber and the housing, and communicates an interior of the heating chamber and an exterior of the housing. The sound detection unit is disposed in the communicating portion, and detects sound.

### CROSS-REFERENCE TO RELATED APPLICATIONS

This application claims the benefit of priority to Japanese Patent Application Number 2020-187986 filed on Nov. 11, 2020. The entire contents of the above-identified application are hereby incorporated by reference.

### TECHNICAL FIELD

The disclosure relates to a heating cooking apparatus.

### BACKGROUND

Heating cooking apparatuses such as microwave ovens, ovens, and toasters have been known (refer to, for example, JP 6579301 B). The heating cooking apparatus of JP 6579301 B includes a heating chamber and an image capturing unit. The heating chamber accommodates a food product. A through hole is formed in a side wall surface of the heating chamber. The image capturing unit captures an image of an inside of the heating chamber through the through hole.

In a heating cooking apparatus such as that of JP 6579301 B, an image of the inside of the heating chamber is captured by the image capturing unit, making it possible for a user to visually observe the captured image and thus identify a progress of cooking. Accordingly, overcooking and undercooking of the food product can be suppressed.

### SUMMARY

Nevertheless, in a heating cooking apparatus such as that of JP 6579301 B, the user needs to visually observe the image in order to identify the progress of cooking. Accordingly, the user temporarily stops other tasks, making visual observation of the image cumbersome for the user.

The disclosure has been made in view of the above-described problems, and an object thereof is to provide a heating cooking apparatus that makes it possible to identify a progress of cooking without visual observation.

A heating cooking apparatus according to an aspect of the disclosure includes a heating chamber, a housing, a communicating portion, and a sound detection unit. The heating chamber is configured to accommodate an object to be heated. The housing is configured to accommodate the heating chamber. The communicating portion is disposed between the heating chamber and the housing, and is configured to communicate an interior of the heating chamber and an exterior of the housing. The sound detection unit is disposed in the communicating portion, and is configured to detect sound.

According to the disclosure, it is possible to provide a heating cooking apparatus that makes it possible to identify a progress of cooking without visual observation.

### BRIEF DESCRIPTION OF DRAWINGS

The disclosure will be described with reference to the accompanying drawings, wherein like numbers reference like elements.

FIG. 1 is a schematic front view illustrating an appearance of a heating cooking apparatus according to a first embodiment of the disclosure.

FIG. 2 is a schematic cross-sectional view illustrating, from a front surface side, an internal structure of the heating cooking apparatus according to the first embodiment.

FIG. 3 is a block diagram illustrating a configuration of the heating cooking apparatus according to the first embodiment.

FIG. 4 is a perspective view illustrating a structure of a sound detection unit according to the first embodiment.

FIG. 5 is a cross-sectional view illustrating the structure of the sound detection unit according to the first embodiment.

FIG. 6 is a schematic view illustrating a structure around the sound detection unit according to the first embodiment.

FIG. 7 is a cross-sectional view illustrating a structure of the sound detection unit according to a first modified example of the first embodiment.

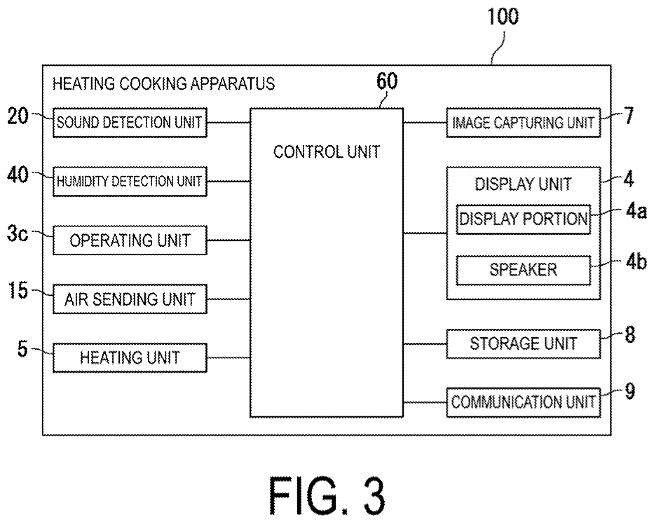

FIG. 3 is a schematic view for explaining the sound detection unit according to the first embodiment.

FIG. 9 is a schematic view for explaining the sound detection unit according to the first embodiment.

FIG. 10 is a schematic view for explaining the sound detection unit according to the first embodiment.

FIG. 11 is a schematic view for explaining the sound detection unit according to the first embodiment.

FIG. 12 is a schematic view for explaining the sound detection unit according to the first embodiment.

FIG. 13 is a schematic view illustrating the sound detection unit according to a second modified example of the first embodiment.

FIG. 14 is a schematic view illustrating the sound detection unit according to a third modified example of the first embodiment.

FIG. 15 is a schematic view illustrating the sound detection unit according to a fourth modified example of the first embodiment.

FIG. 16 is a schematic cross-sectional view illustrating, from a front surface side, an internal structure of a heating cooking apparatus according to a second embodiment of the disclosure.

### DESCRIPTION OF EMBODIMENTS

Below, embodiments of a heating cooking apparatus according to the disclosure will be described with reference to the drawings. Note that, in the drawings, the same or equivalent components are denoted by the same reference signs and description thereof will not be repeated. Further, in this embodiment, an X axis, a Y axis, and a Z axis orthogonal to each other are illustrated in the drawings. The Z axis is parallel to a vertical direction, and the X and Y axes are parallel to a horizontal direction. A positive direction of the Y axis indicates a back surface side of the heating cooking apparatus, and negative direction of the Y axis indicates a front surface side of the heating cooking apparatus. In this embodiment, for the sake of convenience, the front surface side of the heating cooking apparatus may be described as a front side of the heating cooking apparatus, and the back surface side of the heating cooking apparatus may be described as a rear side of the heating cooking apparatus. Further, for the sake of convenience, a Z-axis direction may be described as an up-down direction. A positive direction of the Z axis indicates an upward direction. However, the up-down direction, the upward direction, and a downward direction are determined for convenience of description, and need not correspond to the vertical direction. Further, the up-down direction is merely defined for the sake of convenience of description, and an orientation of the heating cooking apparatus according to the disclosure during use and assembly is not limited.

### First Embodiment

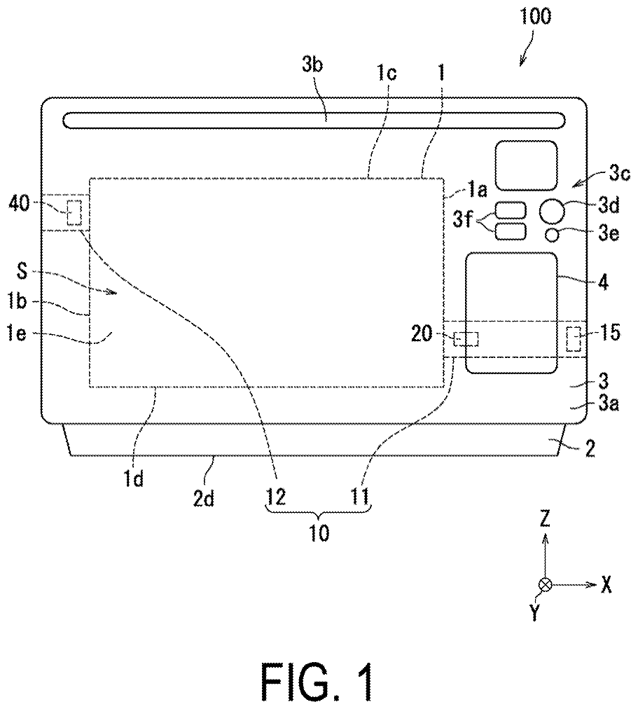

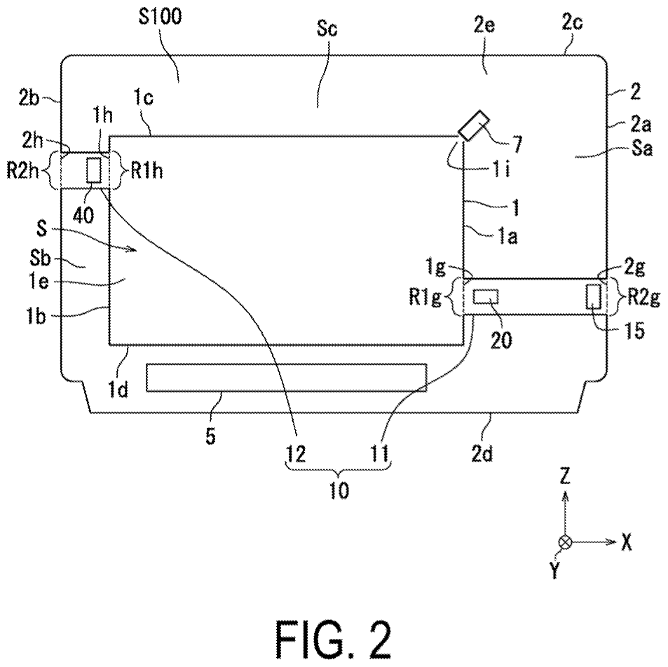

A heating cooking apparatus 100 according to a first embodiment of the disclosure will be described with reference to FIG. 1 and FIG. 2. FIG. 1 is a schematic front view illustrating an appearance of the heating cooking apparatus 100 according to the first embodiment. Note that, in FIG. 1, a viewing window for directly viewing an inside of a heating chamber 1 is not drawn for ease of understanding. FIG. 2 is a schematic cross-sectional view illustrating, from a front surface side, an internal structure of the heating cooking apparatus 100 according to the first embodiment.

As illustrated in FIG. 1 and FIG. 2, the heating cooking apparatus 100 includes at least the heating chamber 1, a housing 2, a communicating portion 10, and a sound detection unit 20. Further, in this embodiment, the heating cooking apparatus 100 further includes an air sending unit 15. Further, in this embodiment, the heating cooking apparatus 100 further includes a humidity detection unit 40. Further, in this embodiment, the heating cooking apparatus 100 further includes a speaker 4b. A detailed description is provided below.

The heating cooking apparatus 100 heats and cooks an object to be heated. The object to be heated includes, for example, a food product. The heating cooking apparatus 100 includes the heating chamber 1, the housing 2, and a door 3.

The heating chamber 1 accommodates the object to be heated. Specifically, the heating chamber 1 is a member having a rectangular parallelepiped shape. The heating chamber 1 includes a heating chamber S that accommodates the object to be heated. The heating chamber S is a space for heating and cooking the object to be heated.

The heating chamber 1 includes a plurality of wall portions. Specifically, the heating chamber 1 includes a side wall 1a, a side wall 1b, an upper wall 1c, a lower wall 1d, and a rear wall 1e. Note that each of the side wall 1a and the side wall 1b is an example of a “wall portion” of the disclosure. The material of the side wall 1a, the side wall 1b, the upper wall 1c, the lower wall 1d, and the rear wall 1e is metal, for example.

The housing 2 accommodates the heating chamber 1. The housing 2 includes a plurality of wall portions. Specifically, the housing 2 includes a side wall 2a, a side wall 2b, an upper wall 2c, a lower wall 2d, and a rear wall 2e. The material of the side wall 2a, the side wall 2b, the upper wall 2c, the lower wall 2d, and the rear wall 2e is metal, for example.

The door 3 is disposed on a front surface side of the housing 2. The door 3 opens and closes the heating chamber 1. The door 3 includes a front surface 3a, a handle 3b disposed on an upper portion of the front surface 3a, and an operating unit 3c disposed on the front surface 3a. The operating unit 3c receives an operation from the user. The operating unit 3c includes, for example, a start button 3d, a stop button 3e, and a condition setting button 3f. The start button 3d is a button for starting heating. The stop button 3e is a button for stopping heating. The condition setting button 3f is a button for setting heating conditions, such as a heating time and a heating temperature. Note that at least a portion of the door 3 may be formed of glass, for example, having translucency and heat resistance so that a user can visually observe the inside of the heating chamber 1.

FIG. 3 is a block diagram illustrating a configuration of the heating cooking apparatus 100 according to the first embodiment. As illustrated in FIG. 1 and FIG. 3, the heating cooking apparatus 100 includes the speaker 4b. Further, the heating cooking apparatus 100 includes a display portion 4a. Specifically, the heating cooking apparatus 100 includes a display unit 4. The display unit 4 is disposed on the front surface 3a of the door 3. The display unit 4 includes the display portion 4a and the speaker 4b. The display portion 4a includes a liquid crystal panel, for example. The display portion 4a displays an image. In this embodiment, the display portion 4a displays an image captured by an image capturing unit 7. The speaker 4b outputs sound detected by the sound detection unit 20. Accordingly, the sound detected by the sound detection unit 20 can be output from the heating cooking apparatus 100. Note that, in a case in which the sound detected by the sound detection unit 20 is output from another device such as a smartphone, the heating cooking apparatus 100 need not include the speaker 4b.

Further, as illustrated in FIG. 2 and FIG. 3, the heating cooking apparatus 100 includes a heating unit 5. The heating unit 5 heats the food product in the heating chamber 1. The heating unit 5 is, for example, a microwave supply device. The heating unit 5 supplies microwaves into the heating chamber 1. The heating unit 5 is disposed, for example, below the heating chamber 1. Note that the heating unit 5 need not be a microwave supply device as long as capable of heating the food product in the heating chamber 1. For example, the heating unit 5 may be a heater that generates heat. Further, the heating unit 5 may blow high-temperature hot air or high-temperature steam into the heating chamber 1.

Further, as illustrated in FIG. 3, the heating cooking apparatus 100 includes a storage unit 8, a communication unit 9, and a control unit 60. The storage unit 8 includes a storage device, and stores data and computer programs. The storage unit 8 includes, for example, a non-temporary computer-readable storage medium. Specifically, the storage unit 8 includes a main storage device such as a semiconductor memory, and an auxiliary storage device such as a semiconductor memory, a solid state drive, and/or a hard disk drive. The storage unit 8 may include a removable medium. The storage unit 8 stores sound data, image data, and the like under the control of the control unit 60.

The communication unit 9 is an interface device for connecting to a communication network (not illustrated). The communication network includes, for example, the internet and a local area network (LAN). In this embodiment, the heating cooking apparatus 100 is capable of communicating with other devices via the communication network. Other devices include at least one of a display portion and a speaker. Examples of other devices include a smartphone and a tablet terminal.

The control unit 60 includes a processor such as a central processing unit (CPU). The processor of the control unit 60 controls the operation of the heating unit 5 and the operation of the display unit 4 by executing a computer program stored in a storage device of the storage unit 8.

The control unit 60 receives a sound signal based on the sound detected by the sound detection unit 20. The control unit 60 generates sound data including a cooking sound based on the received sound signal. The control unit 60 causes the speaker 4b of the display unit 4 to output the sound based on the sound data. The control unit 60 may transmit the sound data to another device via the communication unit 9 to cause the other device to output the sound.

Further, the control unit 60 generates image data on the basis of the captured data received from the image capturing unit 7. The control unit 60 causes the display portion 4a of the display unit 4 to display an image based on the image data. The control unit 60 may transmit the image data to another device via the communication unit 9 to cause the other device to display the image.

Further, the control unit 60 controls the heating unit 5 on the basis of the humidity indicated by a humidity signal received from the humidity detection unit 40.

Further, as illustrated in FIG. 2, the heating cooking apparatus 100 includes a space S100. Specifically, the space S100 is constituted by a space Sa, a space Sb, a space Sc, and a space Se. The space Sa is disposed between the side wall 1a of the heating chamber 1 and the side wall 2a of the housing 2. The space Sb is disposed between the side wall 1b and the side wall 2b. The space Sc is disposed between the upper wail 1c and the upper wall 2c. The space Se is disposed between the rear wall 1e and the rear wall 2e. Further, the heating cooking apparatus 100 may also include a blower (not illustrated) disposed in the space S100. The blower (not illustrated) circulates air through the space S100, thereby cooling an interior of the heating cooking apparatus 100. In this case, it possible to suppress a temperature rise components disposed in the space S100, for example, electronic components.

Here, in this embodiment, the heating cooking apparatus 100 includes the communicating portion 10, as illustrated in FIG. 2. The communicating portion 10 is disposed between the heating chamber 1 and the housing 2. The communicating portion 10 communicates an interior of the heating chamber 1 and an exterior of the housing 2. The communicating portion 10 includes a tube member having, for example, a cylindrical shape or a rectangular cylindrical shape. The communicating portion 10 includes a first communicating portion 11. The first communicating portion 11 guides air from the exterior of the housing 2 to the interior of the heating chamber 1. The first communicating portion 11 connects the side wall 1a of the heating chamber 1 and the side wall 2a of the housing 2. Further, the communicating portion 10 further includes a second communicating portion 12. The second communicating portion 12 connects the side wall 1b of the heating chamber 1 and the side wall 2b of the housing 2. The second communicating portion 12 guides air from the interior of the heating chamber 1 to the exterior of the housing 2.

The side wall 1a of the heating chamber 1 includes a communicating region R1g. The communicating region R1g includes at least one communication hole 1g. Specifically, the communication hole 1g communicates the interior of the heating chamber 1 and an interior of the communicating portion 10 (here, first communicating portion 11). In this embodiment, a plurality of the communication holes 1g are spaced apart from each other. The communicating region R1g includes a plurality of the communication holes 1g. The communicating portion 10 is connected to the side wall 1a and thus surrounds a periphery of the communicating region R1g. Further, the side wall 2a of the housing 2 includes a communicating region R2g. The communicating region R2g includes at least one communication hole 2g. Specifically, the communication hole 2g communicates the exterior of the housing 2 and the interior of the communicating portion 10 (here, first communicating portion 11). In this embodiment, a plurality of the communication holes 2g are spaced apart each other. The communicating region R2g includes a plurality of the communication holes 2g. The communicating portion 10 is connected to the side wall 2a and thus surrounds a periphery of the communicating region R2g.

Further, the side wall 1b of the heating chamber includes a communicating region R1h. The communicating region R1h includes at least one communication hole 1h. Specifically, the communication hole 1h communicates the interior of the heating chamber 1 and the interior of the communicating portion 10 (here, second communicating portion 12). In this embodiment, a plurality of the communication holes 1h are spaced apart from each other. The communicating region R1h includes a plurality of the communication holes 1h. The communicating portion 10 is connected to the side wall 1b and thus surrounds a periphery of the communicating region R1h. Further, the side wall 2b of the housing 2 includes a communicating region R2h. The communicating region R2h includes at least one communication hole 2h. Specifically, the communication hole 2h communicates the exterior of the housing 2 and the interior of the communicating portion 10 (here, second communicating portion 12). In this embodiment, a plurality of the communication holes 2h are spaced apart from each other. The communicating region R2h includes a plurality of the communication holes 2h. The communicating portion 10 is connected to the side wall 2b and thus surrounds a periphery of the communicating region R2h.

In this embodiment, the sound detection unit 20 detects sound. The sound detection unit 20 is disposed in the communicating portion 10. Accordingly, the sound detection unit 20 is capable of detecting the sound in the heating chamber 1. That is, the sound detection unit 20 can detect the cooking sound in the heating chamber 1. Thus, by outputting the detected sound from the speaker 4b, for example, the user can identify the progress of cooking without visually observing the display portion 4a. Further, compared to a case in which the cooking sound cannot be heard, the user is stimulated in appetite and enjoys the cooking. Note that, in a case in which the sound detection unit 20 is not disposed in the communicating portion 10, the cooking sound is drowned out by, for example, a driving sound of the blower (not illustrated) or other noise in the space S100. Thus, it is difficult to detect the cooking sound by the sound detection unit 20. That is, the communicating portion 10 has a function of transmitting the cooking sound in the heating chamber 1 to the sound detection unit 20, and a function of suppressing the drowning out of the cooking sound by noise other than the sound in the heating chamber 1.

In particular, in this embodiment, the sound detection unit 20 is spaced apart from the heating chamber 1. Accordingly, the transmission of the heat of the heating chamber 1 to the sound detection unit 20 is suppressed, making it possible to suppress a temperature rise in the sound detection unit 20.

Further, in this embodiment, the sound detection unit 20 is disposed in the first communicating portion 11. Accordingly, deterioration of the sound detection unit 20 by heat or moisture can be suppressed. Specifically, the air in the heating chamber 1 may become high in temperature due to heat during cooking. Further, the air in the heating chamber 1 may be in a state of containing a significant amount of moisture due to water vapor generated from the food product during cooking. Here, air flows from the first communicating portion 11 to the second communicating portion 12 via the heating chamber 1. Accordingly, the air containing heat and moisture in the heating chamber 1 substantially does not flow into the first communicating portion 11. Thus, contact of air containing heat and moisture with the sound detection unit 20 is suppressed, making it possible to suppress deterioration of the sound detection unit 20 caused by heat and moisture.

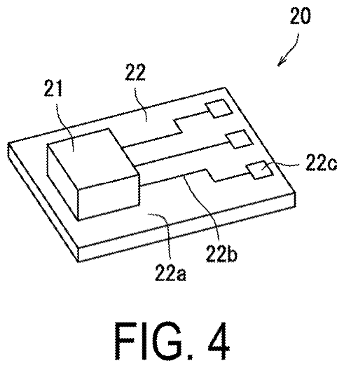

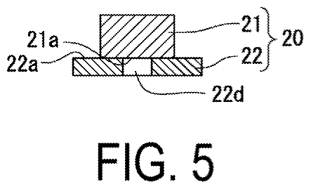

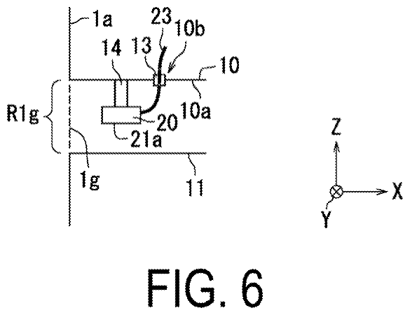

FIG. 4 is a perspective view illustrating a structure of the sound detection unit 20 according to the first embodiment. FIG. 5 is a cross-sectional view illustrating the structure of the sound detection unit 20 according to the first embodiment. FIG. 6 is a schematic view illustrating a structure around the sound detection unit 20 according to the first embodiment. As illustrated in FIG. 4 and FIG. 5, the sound detection unit 20 includes a detection element 21, a substrate 22, and a wiring line 23 (refer to FIG. 6). The detection element 21 detects sound. The detection element 21 includes, for example, a microelectromechanical systems (MEMS) microphone. The detection element 21 includes a detection surface 21a for detecting the sound. The detection element 21 generates a sound signal on the basis of the detected sound, and transmits the sound signal to the control unit 60 (refer to FIG. 3). Note that the detection element 21 includes a sound hole (not illustrated) for capturing the sound in an interior of the detection element 21, and the sound passing through the sound hole is detected by the detection element 21. In this specification, a surface on which the sound hole is disposed is referred to as the detection surface 21a.

The detection element 21 is fixed to the substrate 22. The substrate 22 is made of, for example, resin. The substrate 22 includes a mounting surface 22a and a plurality of wiring portions 22b disposed on the mounting surface 22a. The detection surface 21a of the detection element 21 is fixed to the mounting surface 22a of the substrate 22. The detection element 21 is electrically connected to the wiring portions 22b. The wiring portions 22b are drawn to the outside of the detection element 21. Each of the wiring portions 22b includes an electrode portion 22c. The electrode portion 22c is electrically connected to the control unit 60 via the wiring line 23 (refer to FIG. 6). Further, the substrate 22 includes an opening portion 22d that passes through the substrate 22 in a thickness direction. The opening portion 22d passes the sound therethrough.

### FIRST MODIFIED EXAMPLE

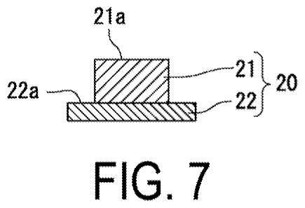

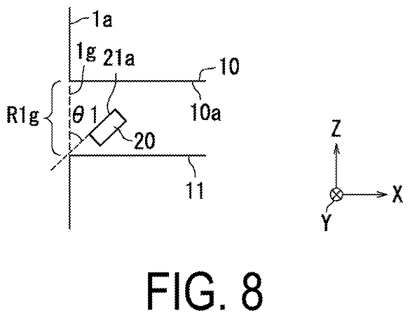

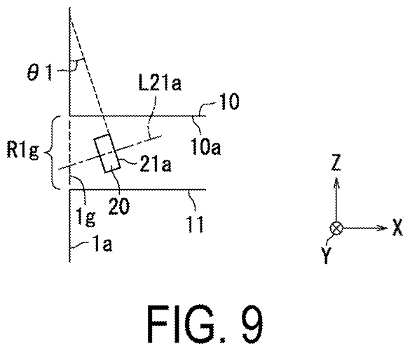

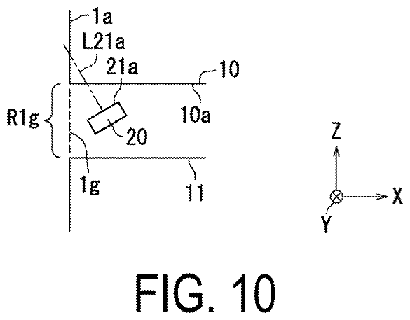

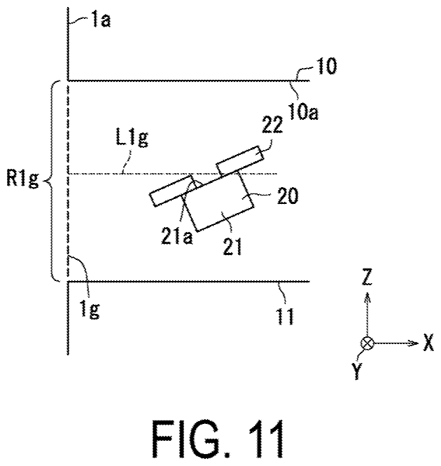

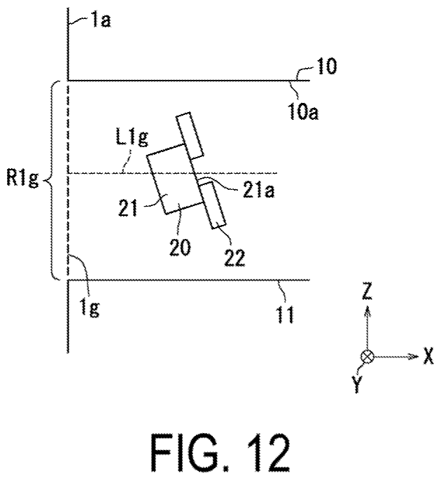

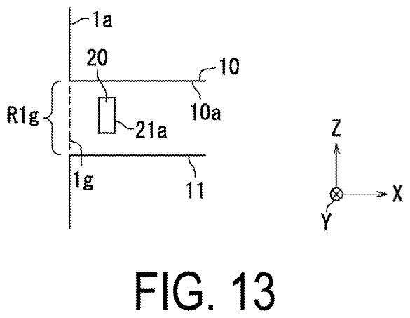

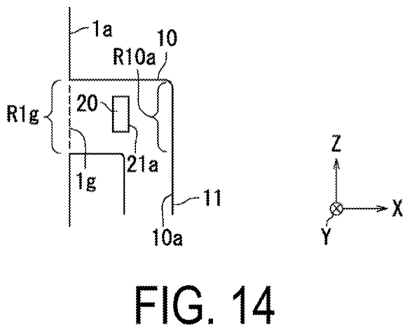

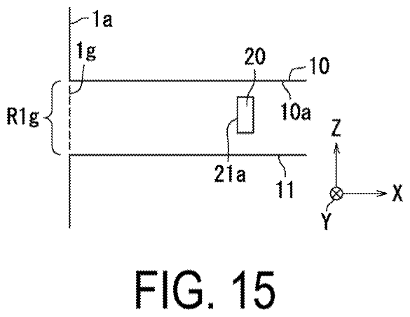

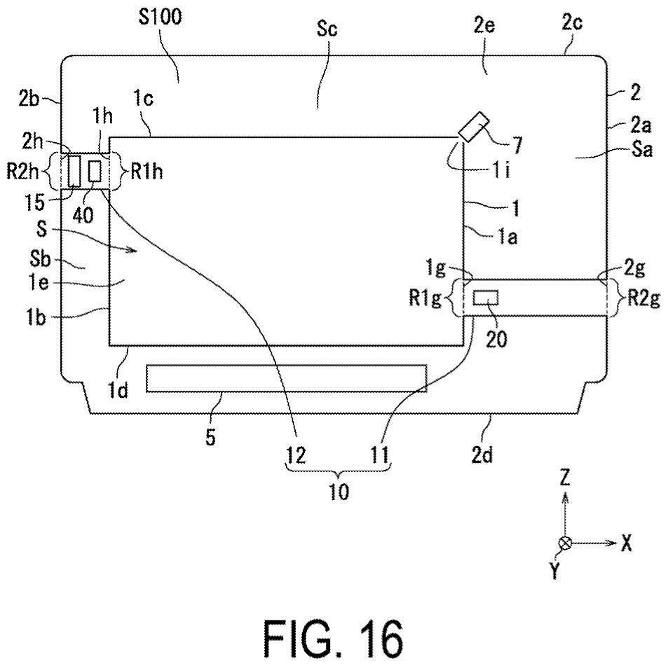

FIG. 7 is a cross-sectional view illustrating a structure of the sound detection unit 20 according to a first modified example of the first embodiment. As illustrated in FIG. 7, in the sound detection unit 20 of the first modified example, a surface opposite to the detection surface 21a of the detection element 21 is fixed to the mounting surface 22a of the substrate 22. That is, the detection surface 21a is disposed opposite the substrate 22. The substrate 22 does not include the opening portion 22d. In the sound detection unit 20 of the first modified example, sound can be detected by the sound detection unit 20 without formation of the opening portion 22d in the substrate 22.

Further, in FIG. 5 and FIG. 7, an example is given in which the detection surface 21a of the detection element 21 is disposed substantially parallel to the mounting surface 22a of the substrate 22, but the arrangement direction of the detection element 21 with respect to the substrate 22 is not particularly limited. That is, the detection surface 21a of the detection element 21 may be disposed not substantially parallel to the mounting surface 22a of the substrate 22. For example, the detection surface 21a of the detection element 21 may be disposed extending in a direction intersecting the mounting surface 22a of the substrate 22.

In continuation, with reference to FIG. 6, the communicating portion 10 will be described. As illustrated in FIG. 6, the communicating portion 10 includes an inner surface 10a, a through hole 10b, a sealing member 13, and a holding member 14. The through hole 10b is disposed on the inner surface 10a. The through hole 10b communicates the interior and an exterior of the communicating portion 10. The wiring line 23 is disposed up to the exterior of the communicating portion 10 via the through hole 10b. The sealing member 13 is fixed to the through hole 10b. The sealing member 13 includes, for example, an O-ring. The sealing member 13 has heat resistance and elasticity. As a material of the sealing member 13, a heat-resistant rubber can be used, for example. The sealing member 13 closes a gap between the wiring line 23 and the through hole 10b. The holding member 14 is fixed to the inner surface 10a of the communicating portion 10. The holding member 14 holds the sound detection unit 20 in a predetermined position and at a predetermined angle. As a material of the holding member 14, metal can be used, for example. Further, a heat-resistant rubber, for example, having heat resistance and elasticity can be used as the material of the holding member 14.

Further, in this embodiment, the detection surface 21a faces downward. Accordingly, it is possible to suppress the falling and adherence of foreign matter contained in the air to the detection surface 21a. Note that the detection surface 21a may be oriented in a direction other than downward. The arrangement direction of the detection surface 21a will be described in detail below.

FIG. 8 to FIG. 12 are schematic views for explaining the sound detection unit 20 according to the first embodiment. Note that, in FIG. 8 to FIG. 12, the wiring line 23, the through hole 10b, the sealing member 13, and the holding member 14 are omitted for ease of understanding.

In this embodiment, the detection surface 21a of the sound detection unit 20 does not directly face the communicating region R1g of the heating chamber 1. Accordingly, even in a case in which, for example, oil splashing from the food product enters the communicating portion 10 via the communication hole 1g, it is possible to suppress the adherence of the oil to the detection surface 21a.

For example, as illustrated in FIG. 8, the fact that the detection surface 21a does not directly face the communicating region R1g indicates that an angle θ1 formed by the detection surface 21a and the communicating region R1g is 45 degrees or greater. However, as illustrated in FIG. 9, even if the angle θ1 formed by the detection surface 21a and the communicating region R1g is less than 45 degrees, in a case in which the detection surface 21a faces a direction different from the direction in which the communicating region R1g is positioned, the detection surface 21a does not directly face the communicating region R1g.

Further, for example, the fact that the detection surface 21a does not directly face the communicating region R1g may indicate that a perpendicular line L21a perpendicular to the detection surface 21a does not intersect the communicating region R1g, as illustrated in FIG. 10. However, as illustrated in FIG. 9, even in a case in which the perpendicular line L21a intersects the communicating region R1g, when the detection surface 21a faces a direction different from the direction in which the communicating region R1g is positioned, the detection surface 21a does not directly face the communicating region R1g.

Further, for example, the fact that the detection surface 21a does not directly face the communicating region R1g may indicate that, as illustrated in FIG. 11, a perpendicular line L1g perpendicular to the communicating region R1g cannot intersect the detection surface 21a without intersecting the substrate 22. However, as illustrated in FIG. 12, even in a case in which the perpendicular line L1g intersects the detection surface 21a without intersecting the substrate 22, when the detection surface 21a faces a direction different from the direction in which the communicating region R1g is positioned, the detection surface 21a does not directly face the communicating region R1g.

### SECOND MODIFIED EXAMPLE

FIG. 13 is a schematic view illustrating the sound detection unit 20 according to a second modified example of the first embodiment. In the second modified example, an example is illustrated in which the detection surface 21a does not directly face the communicating region R1g. As illustrated in FIG. 13, the detection surface 21a of the sound detection unit 20 of the second modified example faces a direction opposite to the direction in which the communicating region R1g is positioned. In this case, for example, it is possible to more reliably suppress the adherence of oil splashing from the food product to the detection surface 21a.

### THIRD MODIFIED EXAMPLE

FIG. 14 is a schematic view illustrating the sound detection unit 20 according to a third modified example of the first embodiment. In the third modified example, another example is illustrated in which the detection surface 21a does not directly face the communicating region R1g. As illustrated in FIG. 14, the detection surface 21a faces a direction opposite to the direction in which the communicating region R1g is positioned. The communicating portion 10 curves. The inner surface 10a of the communicating portion 10 includes an opposing region R10a that faces the communicating region R1g. The sound detection unit 20 is disposed between the communicating region R1g and the opposing region R10a. Accordingly, the sound in the heating chamber 1 passes through the communication hole 1g, is reflected by the opposing region R10a, and reaches the detection surface 21a. Thus, the detection surface 21a readily detects the cooking sound, making it possible to improve the detection accuracy of the sound detection unit 20.

### FOURTH MODIFIED EXAMPLE

FIG. 15 is a schematic view illustrating the sound detection unit 20 according to a fourth modified example of the first embodiment. In the fourth modified example, an example is illustrated in which the detection surface 21a directly faces the communicating region R1g. As illustrated in FIG. 15, the detection surface 21a directly faces the communicating region R1g. However, the detection surface 21a is sufficiently spaced apart from the communicating region R1g. In the fourth modified example, the detection surface 21a is spaced apart from the communicating region R1g by, for example, two times the diameter of the communicating region R1g or greater. Accordingly, it is possible to suppress the adherence of oil splashing from the food product to the detection surface 21a, for example.

Next, with reference to FIG. 2, the air sending unit 15, the humidity detection unit 40, and the image capturing unit 7 will be described. In this embodiment, the heating cooking apparatus 100 includes the air sending unit 15, as illustrated in FIG. 2. The air sending unit 15 causes air to flow through the communicating portion 10. Thus, by driving the air sending unit 15, it is possible to discharge the air in the heating chamber 1 to outside the housing 2 via the second communicating portion 12. Specifically, with the driving of the air sending unit 15, the air outside the housing 2 flows into the first communicating portion 11. The air flowing into the first communicating portion 11 passes through the heating chamber 1 and flows into the second communicating portion 12. The air flowing into the second communicating portion 12 flows outside the housing 2.

When the amount of air flowing through the communicating portion 10 increases, the temperature inside the heating chamber 1 is less likely to rise. Accordingly, an airflow quantity sent by the air sending unit 15 is very low in comparison to an airflow quantity blown by the blower (not illustrated) disposed in the space S100, for example. Thus, noise such as the driving sound generated by the air sending unit 15 is very small in comparison to the noise generated by the blower disposed in the space S100, and the like.

The air sending unit 15 is disposed in the first communicating portion 11. The air sending unit 15 is disposed in a direction opposite to the heating chamber 1 with respect to the sound detection unit 20. That is, the sound detection unit 20 is disposed closer to the heating chamber 1 than the air sending unit 15 is. Accordingly, the air sending unit 15 is not disposed between the heating chamber 1 and the sound detection unit 20, and therefore the cooking sound in the heating chamber 1 is not blocked by the air sending unit 15. Thus, it is possible to suppress a reduction in the detection accuracy of the cooking sound by the sound detection unit 20.

Further, in this embodiment, the heating cooking apparatus 100 includes the humidity detection unit 40 that detects humidity. The humidity detection unit 40 is disposed in the second communicating portion 12. Accordingly, the humidity detection unit 40 can be used to detect the humidity of the air flowing through the second communicating portion 12. Specifically, air containing water vapor generated from the food product flows from the heating chamber 1 into the second communicating portion 12. Thus, by detecting the humidity in the second communicating portion 12 using the humidity detection unit 40, the control unit 60 can estimate the degree of heating of the food product. Further, the humidity detection unit 40 generates a humidity signal indicating the detected humidity and transmits the generated humidity signal to the control unit 60. Further, in a case in which the communicating portion 10 is provided for the detection of the humidity in the heating chamber 1 by the humidity detection unit 40, the communicating portion 10 can be utilized to detect the sound in the heating chamber 1. That is, it is not necessary to provide a dedicated communicating portion for disposing the sound detection unit 20 separately from the communicating portion 10. Accordingly, an increase in size of the heating cooking apparatus 100 can be suppressed.

Further, the humidity detection unit 40 is spaced apart from the heating chamber 1. Accordingly, the transmission of the heat of the heating chamber 1 to the humidity detection unit 40 is suppressed, making it possible to suppress a temperature rise in the humidity detection unit 40. Note that, similarly to the sound detection unit 20, the humidity detection unit 40 is held in a predetermined position by a holding member (not illustrated).

In this embodiment, the heating cooking apparatus 100 includes the image capturing unit 7. The image capturing unit 7 is spaced apart from the heating chamber 1. Accordingly, transmission of the heat of the heating chamber to the image capturing unit 7 is suppressed, making it possible to suppress a temperature rise in the image capturing unit 7.

The image capturing unit 7 captures an image of the inside of the heating chamber 1. Accordingly, the control unit 60 can display the image of the inside of the heating chamber 1 captured by the image capturing unit 7 on the display portion 4a, for example. Specifically, the heating chamber 1 includes a communication hole 1i. The communication hole 1i communicates the interior and an exterior of the heating chamber 1. The image capturing unit 7 captures a cooking state of the food product in the heating chamber 1 via the communication hole 1i. The communication hole 1i is disposed in connecting portion between the side wall 1a and the upper wall 1c, for example. As long as the image capturing unit 7 is capable of capturing the cooking state of the food product, the position of the communication hole 1i is not particularly limited, but is preferably in an upper portion of the heating chamber 1. Further, the image capturing unit 7 generates image data on the basis of the captured image and transmits the image data to the control unit 60.

### Second Embodiment

A heating cooking apparatus 100 according to a second embodiment of the disclosure will be described with reference to FIG. 16. In the second embodiment, an example is described in which an air sending unit 15 is disposed in a second communicating portion 12, unlike the first embodiment. FIG. 16 is a schematic cross-sectional view illustrating, from a front surface side, an internal structure of the heating cooking apparatus 100 according to the second embodiment of the disclosure.

In this embodiment, as illustrated in FIG. 16, the air sending unit 15 is disposed in the second communicating portion 12. Accordingly, when the noise generated in the air sending unit 15 is detected by a sound detection unit 20, the noise passes through a heating chamber 1. Thus, in comparison to a case in which the air sending unit 15 is disposed in the same single tube (first communicating portion 11) as the sound detection unit 20 as in the first embodiment, the noise generated in the air sending unit 15 is less likely to be detected by the sound detection unit 20. Thus, the detection accuracy of the cooking sound by the sound detection unit 20 can be improved.

Other structures and other effects of the second embodiment are similar to those of the first embodiment.

The embodiments of the disclosure have been described above with reference to the drawings. However, the disclosure is not limited to the embodiments described above, and it is possible to implement the disclosure in various modes without departing from the gist of the disclosure. Further, the disclosure can be made in various forms by appropriately combining a plurality of components disclosed in the embodiments described above. For example, several components may be deleted from all of the components described in the embodiments. Furthermore, the components across different embodiments may be appropriately combined. For easier understanding, the drawings schematically illustrate the respective main components, and the thickness, length, number, interval or the like of illustrated components may differ from actuality for the sake of convenience in creating the drawings. The material, shape, dimensions, and the like of each of the components illustrated in the embodiments described above are merely exemplary and are not particularly limited, and various modifications can be made within the scope not departing from the effects of the disclosure in essence.

For example, in the first embodiment and the second embodiment described above, an example is given in which the communicating portion 10 includes the first communicating portion 11 and the second communicating portion 12, but the disclosure is not limited to this example. For example, the communicating portion 10 may include only one communicating portion that communicates the interior of the heating chamber 1 and the exterior of the housing 2.

Further, in the first embodiment and second embodiment described above, an example is given in which the heating cooking apparatus 100 includes the air sending unit 15, and air flows from the first communicating portion 11 to the second communicating portion 12 via the heating chamber 1. However, the disclosure is not limited to this example. That is, the heating cooking apparatus 100 need not be configured with the air flowing through the communicating portion 10.

Further, in the first embodiment and the second embodiment described above, an example is given in which the sound detection unit 20 is disposed in the first communicating portion 11, but the disclosure is not limited to this example. For example, the sound detection unit 20 may be disposed in the second communicating portion 12.

Further, in the first embodiment and the second embodiment described above, an example is given in which the heating cooking apparatus 100 includes the humidity detection unit 40, but the disclosure is not limited to this example. The heating cooking apparatus 100 need not include the humidity detection unit 40. Further, the heating cooking apparatus 100 may include an ion generator configured to generate ions having a sterilizing function or a deodorizing function, for example. In this case, the ion generator is preferably disposed in the first communicating portion 11, unlike the humidity detection unit 40.

Further, in the first embodiment and the second embodiment described above, an example is given in which the heating cooking apparatus 100 includes the image capturing unit 7 and the display portion 4a, but the disclosure is not limited to this example. The heating cooking apparatus 100 need not include the image capturing unit 7 and the display portion 4a.

Further, in the first embodiment and the second embodiment described above, an example is given in which the heating cooking apparatus 100 includes one sound detection unit 20, but the heating cooking apparatus 100 may include a plurality of sound detection units 20.

Further, the heating cooking apparatus 100 may be configured to remove noise components from the sound detected by the sound detection unit 20. Specifically, the sound detection unit 20 may be configured to reduce noise components by using, for example, a noise suppression technique. Further, the heating cooking apparatus 100 may further include a noise detection unit configured to detect noise in the space between the heating chamber 1 and the housing 2, for example, and may reduce noise components from the sound detected by the sound detection unit 20 on the basis of the sound detected by the noise detection unit. Note that, as a method for reducing noise components from the sound detected by the sound detection unit 20 on the basis of the sound detected by the noise detection unit, a beam forming technique and an echo cancellation technique, for example, can be used.

Further, the control unit 60 may stop the heating unit 5 or increase or decrease the output of the heating unit 5 on the basis of, for example, a change in frequency of the cooking sound, a change in amplitude of the cooking sound, or a change in number of generated cooking sounds per unit time.

### INDUSTRIAL APPLICABILITY

The disclosure is useful the field of a heating cooking apparatus.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A heating cooking apparatus comprising:
a heating chamber configured to accommodate an object to be heated;
a housing configured to accommodate the heating chamber;
a communicating portion disposed between the heating chamber and the housing and configured to communicate an interior of the heating chamber and an exterior of the housing; and
a sound detection unit disposed in the communicating portion and configured to detect sound.

2. The heating cooking apparatus according to claim 1, further comprising:
an air sending unit configured to circulate air through the communicating portion,
wherein the communicating portion includes a first communicating portion configured to guide air from the exterior of the housing to the interior of the heating chamber, and
the sound detection unit is disposed in the first communicating portion.

3. The heating cooking apparatus according to claim 2, further comprising:
a humidity detection unit configured to detect humidity,
wherein the communicating portion further includes a second communicating portion configured to guide air from the interior of the heating chamber to the exterior of the housing, and
the humidity detection unit is disposed in the second communicating portion.

4. The heating cooking apparatus according to claim 2,
wherein the air sending unit is disposed in the first communicating portion, and
the sound detection unit is disposed closer to the heating chamber than the air sending unit is.

5. The heating cooking apparatus according to claim 2,
wherein the air sending unit is disposed in the second communicating portion.

6. The heating cooking apparatus according to claim 1,
wherein the sound detection unit is spaced apart from the heating chamber.

7. The heating cooking apparatus according to claim 1,
wherein the heating chamber includes a wall portion connected to the communicating portion,
the wall portion includes a communicating region including at least one communication hole,
the at least one communication hole is configured to communicate the interior of the heating chamber and an interior of the communicating portion,
the sound detection unit includes a detection surface configured to detect sound, and
the detection surface does not directly face the communicating region.

8. The heating cooking apparatus according to claim 7,
wherein the detection surface faces downward.

9. The heating cooking apparatus according to claim 7,
wherein the detection surface faces a direction opposite to the communicating region.

10. The heating cooking apparatus according to claim 1, further comprising:
a speaker configured to output the sound detected by the sound detection unit.

11. The heating cooking apparatus according to claim 10, further comprising:
an image capturing unit configured to capture an image of an inside of the heating chamber; and
a display portion configured to display the image captured by the image capturing unit.
